(19) United States
(12) Patent Application Publication
(10) Pub. No.: US 2007/0165109 A1
(43) Pub. Date: Jul. 19, 2007

(54) Universal electronic device remote control power button status light

(76) Inventors: Neal Kenneth Jacobs, Carmel, IN (US); Gregg Michael Morgan, Carmel, IN (US); John Dan Mabry, Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/589,416

(22) PCT Filed: Mar. 8, 2004
(86) PCT No.: PCT/US04/07077

§ 371 Date: Aug. 15, 2006

(51) Int. Cl. H04N 5/335; H04N 5/30

(52) U.S. Cl. 348/162

(57) ABSTRACT

A system comprising a first remote controllable appliance and a universal remote control having an indicator light positioned under a power key for indicating that a device soft key has been activated, or that a function signal has been transmitted for controlling the selected remote controllable appliance.

### FIELD OF THE INVENTION

This invention pertains to the field of universal remote control for appliances.

### BACKGROUND OF THE INVENTION

It is now common practice to include a ‘multi-function’ or ‘Universal’ remote control (URC) hand held transmitter with many consumer products (also referred to herein as devices, apparatus or appliances) such as televisions, video cassette recorders (VCR), digital video disk players (DVD), satellite receivers, compact disk players (CD), and audio systems, to name a few. The advantage of URC's is that the consumer can control not only the particular appliance with which it was sold (hereinafter referred to as “first” appliance), but the consumer can use the same device to control any of the other appliances (hereinafter referred to as “different” appliance).

Because of the need to be able to control so many different appliances, i.e., TV, VCR, DVD, cable, satellite, stereo, and others, it has become common practice to provide one or more “soft” keys on the URC to select the device that is being addressed by the remote control at a particular time. Each time such soft key is pressed, the URC is programmed to toggle between controlling each different appliance. In the case of one such soft key, if the URC is currently controlling the TV, pressing such soft key once may toggle the control to VCR, whereas pressing it twice may toggle it to DVD. In the case of separate soft keys for each type of appliance, the URC may have one soft key for toggling the URC to control the TV, and another soft key to toggle the URC to control a first VCR, and yet another to toggle the URC to control a second VCR, and so on.

Whether a single soft key is used to cause the URC to toggle between controlling different appliances or one soft key is provided for each type of different appliance, an indicator light is typically activated to indicate that a device soft key (or any other key) or programming mode of the remote has been activated. In some cases, the status indicator light is positioned by itself at the top of the remote control. For such an arrangement light is emitted from leaded light emitting diodes (LEDs) fit up to the inner surface of the case top as shown in FIG. 1. Fitting the LED in place is typically difficult and costly.

Alternatively, a status indicator light may be positioned underneath each device soft key as shown in FIGS. 2A-2C. For this option, a separate LED is needed for each device soft key since the key is lit as the status indicator. It is costly to use an LED for each device soft key.

### SUMMARY OF THE INVENTION

These and other objects are solved by the present invention which comprises in one aspect a system comprising a first remote controllable appliance and a universal remote control transmitter having an indicator light positioned under a power key for indicating that a device soft key has been activated, or that a function signal has been transmitted for controlling the selected remote controllable appliance or programming of the remote controllable appliance is taking place. There are several advantages to the present invention, for example the low cost in that it can be implemented with only one surface mounted LED, freeing up space on the circuit board as well as reducing power consumption and simplified manufacturing and assembly of the remote.

### BRIEF DESCRIPTION OF THE DRAWINGS

The invention is explained in more detail below with reference to exemplary embodiments, using the drawings.

FIG. 1 illustrates a prior art remote control;

FIGS. 2A-2C show another prior art remote control; and

FIGS. 3A-3C depict a remote control of the present invention having an indicator light positioned under a power key.

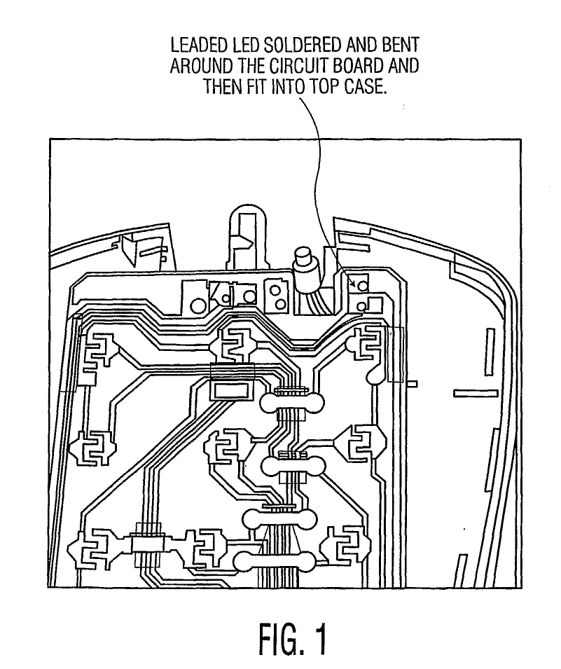

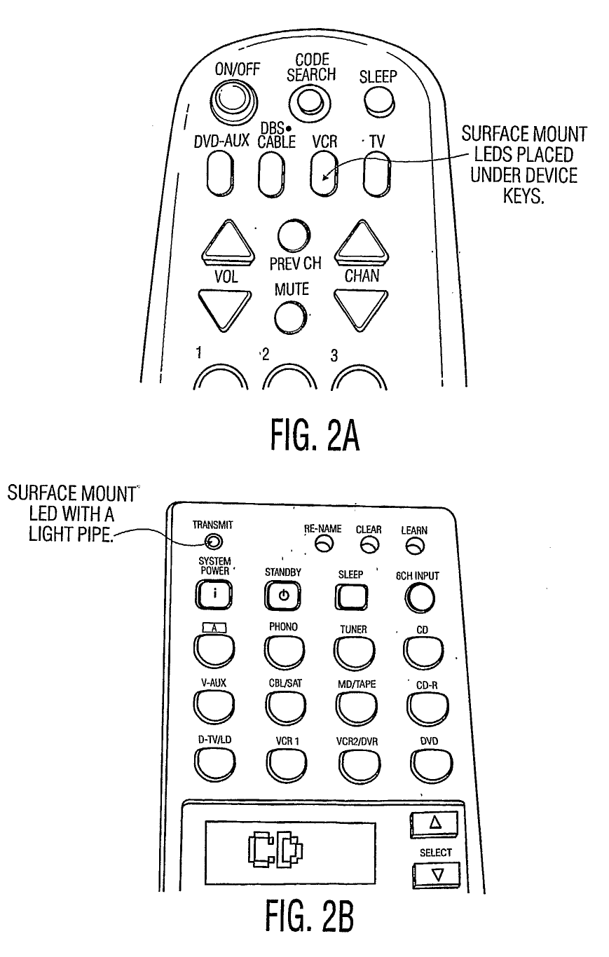

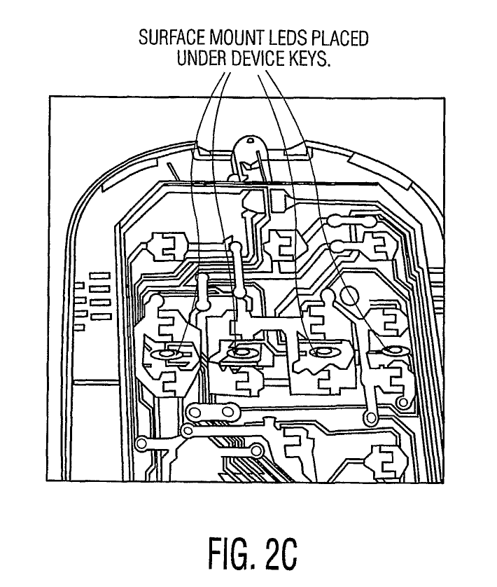

### DETAILED DESCRIPTION

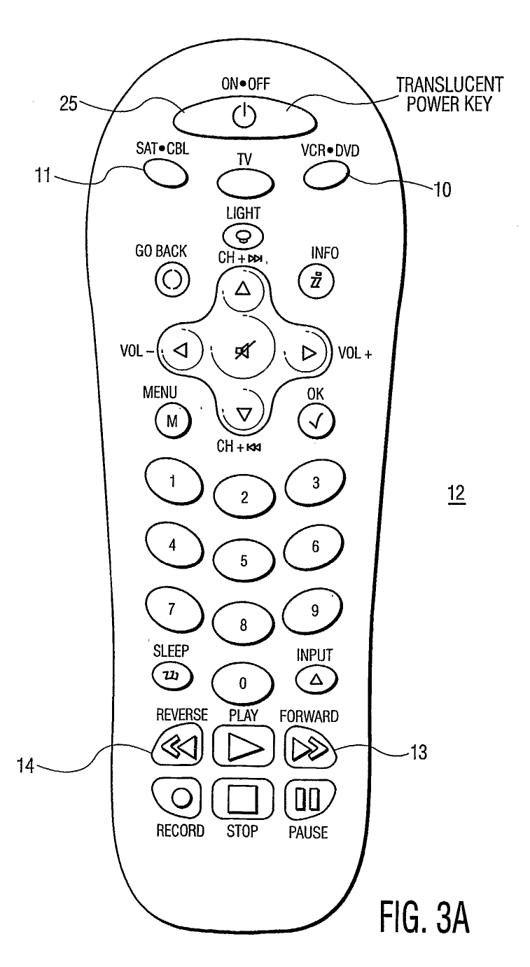

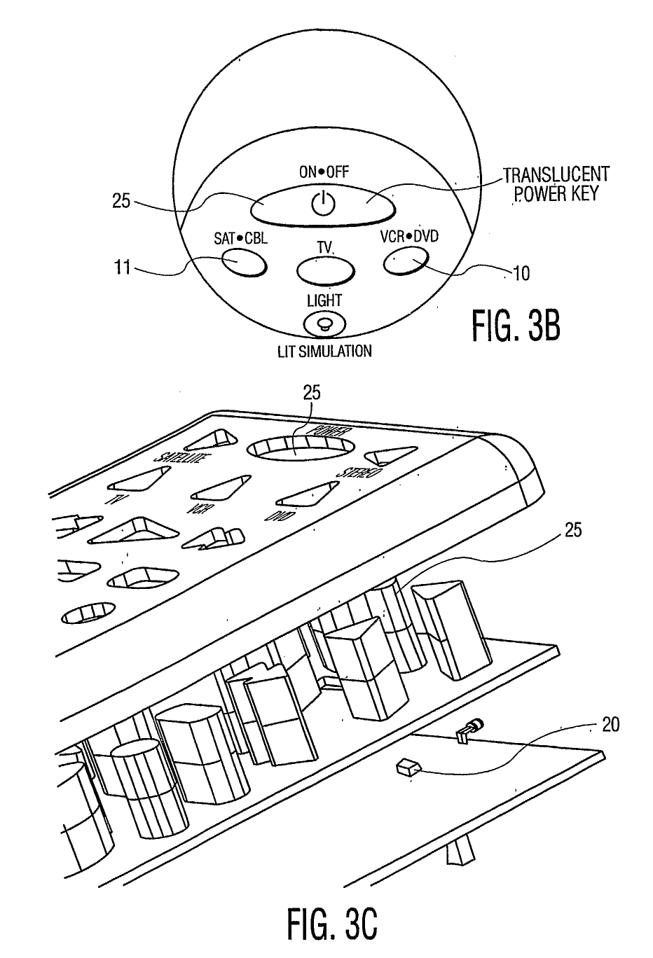

Referring to FIGS. 3A-3C, a hand held universal remote control 12 is provided with control keys 13, 14, etc., and one or more appliance function keys 11, 10, etc., which cause a microprocessor to toggle between control of the various appliances, or appliance functions. For example, the microprocessor can be toggled to control, for example, a television, VCR, DVD, audio system, satellite receiver, cable box, an oven, or any of a wide variety of appliances as well as change television channels and/or volume.

In one embodiment shown in FIG. 3C, the universal remote control 12 includes an indicator light 20 positioned under a power key 25 for indicating that a device control key 13, 14 or function key 11, 10 has been activated, or that a function signal has been transmitted for controlling the selected remote controllable appliance. The indicator light 20 may be for example, a surface mounted light emitting diode (LED). There are several advantages to the present invention, for example the low cost in that it can be implemented with only one surface mounted LED, freeing up space on the circuit board as well as reducing power consumption, creating a larger viewable lit area for the consumer and simplified manufacturing and assembly of the remote.

Pressing the control keys 13, 14, etc., or the function keys 11, 10 etc. causes the microprocessor to instruct the transmitter to send a control code, or a function code, depending on which appliance is selected or toggled in the transmitter microprocessor memory. For example, if the universal remote control transmitter has been toggled to control a VCR, pressing the ON control key will cause the microprocessor to cause the transmitter to send the ON control code which is received by the VCR and processed to control the ON function of the VCR, but that code has no effect on the other appliances which may receive it, for example the television, audio system, etc.

While the invention has been described with respect to certain embodiments, various modifications, alternative embodiments, improvements, and variances should become readily apparent without departing from the spirit and scope of the invention.

What is claimed is:

1. A universal remote control system, comprising
at least one remotely controllable appliance;
a universal remote control having one or more selection keys for selecting for control the at least one remotely controllable appliance and having a plurality of function keys for causing a control signal to be transmitted for controlling the function of the at least one remotely controllable appliance; and
an indicator light positioned under a power key on the universal remote control, wherein the indicator light functions to indicate that the control signal has been transmitted to the at least one remotely controllable appliance for controlling the function thereof.

2. The system of claim 1 wherein the at least one remotely controllable device is selected from the group consisting of video cassette recorders, cable boxes, audio systems, Satellite decoders, DVD players and DBS receivers.

3. A universal remote control, comprising
one or more selection keys for selecting for control at least one remotely controllable appliance and having a plurality of function keys for causing a control signal to be transmitted for controlling the function of the at least one remotely controllable appliance; and
an indicator light positioned under a power key on the universal remote control, wherein the indicator light functions to indicate that the control signal has been transmitted to the at least one remotely controllable appliance for controlling the function thereof.

4. The universal remote control of claim 3 wherein the at least one remotely controllable device is selected from the group consisting of video cassette recorders, cable boxes, audio systems, Satellite decoders, DVD players and DBS receivers.
